(19) United States
(12) Patent Application Publication
(10) Pub. No.: US 2013/0067338 A1
(43) Pub. Date: Mar. 14, 2013

(54) DYNAMIC NAVIGATION REGION BASED ON SITE USAGE

(71) Applicants: Jonathan F. Kern, Kirkland, WA (US); Nathaniel Granor, Kirkland, WA (US); Richard Eric Andeen, Seattle, WA (US); Charles Keller Smith, Seattle, WA (US); Ashok Kuppusamy, Seattle, WA (US)

(72) Inventors: Jonathan F. Kern, Kirkland, WA (US); Nathaniel Granor, Kirkland, WA (US); Richard Eric Andeen, Seattle, WA (US); Charles Keller Smith, Seattle, WA (US); Ashok Kuppusamy, Seattle, WA (US)

(73) Assignee: MICROSOFT CORPORATION, Redmond, WA (US)

(21) Appl. No.: 13/231,970

(22) Filed: Sep. 14, 2011

(51) Int. Cl. G06F 3/00

(52) U.S. Cl. 715/738

(57) ABSTRACT

A request for a page in a site can be received. The page can include a dynamic navigation region. The dynamic navigation region can be automatically updated based on usage of the site by multiple user profiles. The updating can include querying multiple sources of navigation item data and compiling a record of dynamic navigation items to be displayed in the dynamic navigation region. The page can be generated with the dynamic navigation region, and the page can be returned in response to the page request. Also, a request to pin a navigation item from the dynamic navigation region to the static navigation region can be received. In response to the request to pin, the pinned navigation item can be added to the static navigation region, and the page can be returned with the pinned navigation item added to the static navigation region.

### BACKGROUND

It can be difficult to effectively present navigation items for information collections such as Web sites. A site is a collection of one or more related digital pages and possibly other digital content items that can be reached by navigating the pages(s). For example, these other items may include folders, lists, libraries, documents, apps, etc. As used herein, an “app” is a packaged feature that can be installed on a site to provide added functionality. A navigation item is an item that can be displayed and selected to launch a corresponding content item. For example, the corresponding content item may be a page, a library, a list, an app, etc.

A navigation region of a page may include an exhaustive list of navigation items for all the content items in a site. However, the number of navigation items in such a navigation region could be so large as to make the navigation region unwieldy, or even unusable. Accordingly, some sites present navigation regions that attempt to present only navigation items that are deemed important according to some technique. For example, a navigation region may only include navigation items that have been specifically designated by user input. As another example, a navigation region may include navigation items corresponding to content items that have been most recently created.

### SUMMARY

Tools and techniques described below relate to dynamic navigation regions for a site, where the dynamic regions can include navigation items for navigating the site. The dynamic regions can be automatically updated based on usage of the site by multiple user profiles. As used herein a user profile is a profile can be utilized by one or more users, but the profile may or may not represent an actual user. For example, a user profile may be a profile for a person, for a group of people, for a project, for an asset, etc.

In one embodiment, the tools and techniques can include receiving a request for a page in a site. The page can include a dynamic navigation region. The dynamic navigation region can be automatically updated based on usage of the site by multiple user profiles. This updating can include querying multiple sources of navigation item data and compiling a record of dynamic navigation items to be displayed in the dynamic navigation region. The page can be generated with the dynamic navigation region (i.e., so that the page includes the dynamic navigation region), and the page can be returned in response to the request for the page.

In another embodiment of the tools and techniques, a request for a page in a site can be received. The page can include a dynamic navigation region and a static navigation region. The dynamic navigation region can be automatically updated based on usage of the site by multiple user profiles. The page can be generated with the dynamic navigation region, and the page can be returned in response to the request for the page. A request to pin a navigation item from the dynamic navigation region to the static navigation region can be received. As used herein, pinning refers to adding a navigation item in the static navigation region, as directed by user input. In response to the request to pin, the following may be performed: adding the pinned navigation item to the static navigation region; and returning the page with the pinned navigation item added to the static navigation region.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is a schematic diagram of a site usage-based dynamic navigation region environment.

FIG. 3 is an illustration of an example of a navigation area of a site page.

FIG. 4 is an illustration of the navigation area of FIG. 3 after selection of a link editing item to enter a link editing mode that allows pinning/unpinning of items from a static navigation region.

FIG. 5 is an illustration of the navigation area of FIG. 4, illustrating an example of a “WORK SCHEDULE” navigation item having been dragged to a static navigation region to pin the item to that region.

FIG. 6 is an illustration of the navigation area of FIG. 5, after the “WORK SCHEDULE” navigation item has been pinned to the static navigation region.

FIG. 7 is a flowchart illustrating a site usage-based dynamic navigation region technique.

FIG. 8 is a flowchart illustrating another site usage-based dynamic navigation region technique.

FIG. 9 is a flowchart illustrating yet another site usage-based dynamic navigation region technique.

### DETAILED DESCRIPTION

Embodiments described herein are directed to techniques and tools for improved site navigation regions. Such improvements may result from the use of various techniques and tools separately or in combination.

Such techniques and tools may include providing a region of a navigation area that dynamically updates what navigation items are included in the navigation region, based on multiple factors. Such factors may include creation dates of candidate items, recency of usage of candidate items, volume of usage of candidate items, etc. Such factors can encompass usage of the site by multiple different user profiles, so that the inclusion of navigation items in the dynamic region can be based on use of the site by those multiple user profiles. Accordingly, the dynamic region can adapt as site usage changes. For example, the dynamic region can adapt as different content items are created, as different content items are used more or less frequently, etc.

In addition to the dynamic region, the navigation area of a site may also include a static region. These two regions may be located adjacent to each other on the site page or they may be spaced apart or separated from each other in some manner. The static region can include navigation items that have been pinned to the static region, i.e., that have been added in response to explicit user input requesting the additions. Such navigation items in the static region can be omitted from the dynamic region, even if those navigation items would otherwise meet the criteria for being included in the dynamic region. Items in the dynamic region may be pinned to the static region. In this sense, the dynamic region can act as a suggestion list for things that might be useful in the more permanent static navigation region.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Moreover, for the sake of simplicity, flowcharts may not show the various ways in which particular techniques can be used in conjunction with other techniques.

Techniques described herein may be used with one or more of the systems described herein and/or with one or more other systems. For example, the various procedures described herein may be implemented with hardware or software, or a combination of both. For example, dedicated hardware implementations, such as application specific integrated circuits, programmable logic arrays and other hardware devices, can be constructed to implement at least a portion of one or more of the techniques described herein. Applications that may include the apparatus and systems of various embodiments can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionality, as described herein.

### I. Exemplary Computing Environment

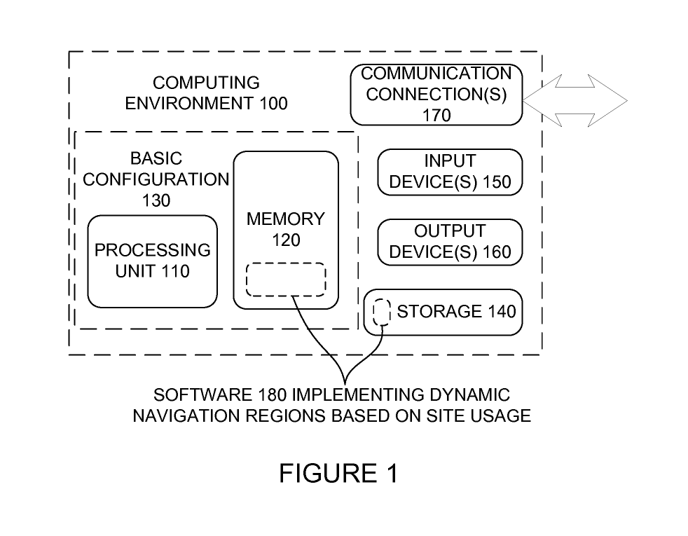

FIG. 1 illustrates a generalized example of a suitable computing environment (100) in which one or more of the described embodiments may be implemented. For example, one or more such computing environments can be used as a server for a site and/or a client for a site. Generally, various different general purpose or special purpose computing system configurations can be used. Examples of well-known computing system configurations that may be suitable for use with the tools and techniques described herein include, but are not limited to, server farms and server clusters, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, the computing environment (100) includes at least one processing unit (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing dynamic navigation regions based on site usage.

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include computer-readable storage media such as magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) may be a touch input device such as a keyboard, mouse, pen, or trackball; a voice input device; a scanning device; a network adapter; a CD/DVD reader; or another device that provides input to the computing environment (100). The output device(s) (160) may be a display, printer, speaker, CD/DVD-writer, network adapter, or another device that provides output from the computing environment (100).

The communication connection(s) (170) enable communication over a communication medium to another computing entity. Thus, the computing environment (100) may operate in a networked environment using logical connections to one or more remote computing devices, such as a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media, which may be storage media or communication media. Computer-readable storage media are any available storage media that can be accessed within a computing environment, but the term computer-readable storage media does not refer to propagated signals per se. By way of example, and not limitation, with the computing environment (100), computer-readable storage media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media.

For the sake of presentation, the detailed description uses terms like “determine,” “add,” “remove,” and “pin” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. Site Usage-Based Dynamic Navigation Region System and Environment

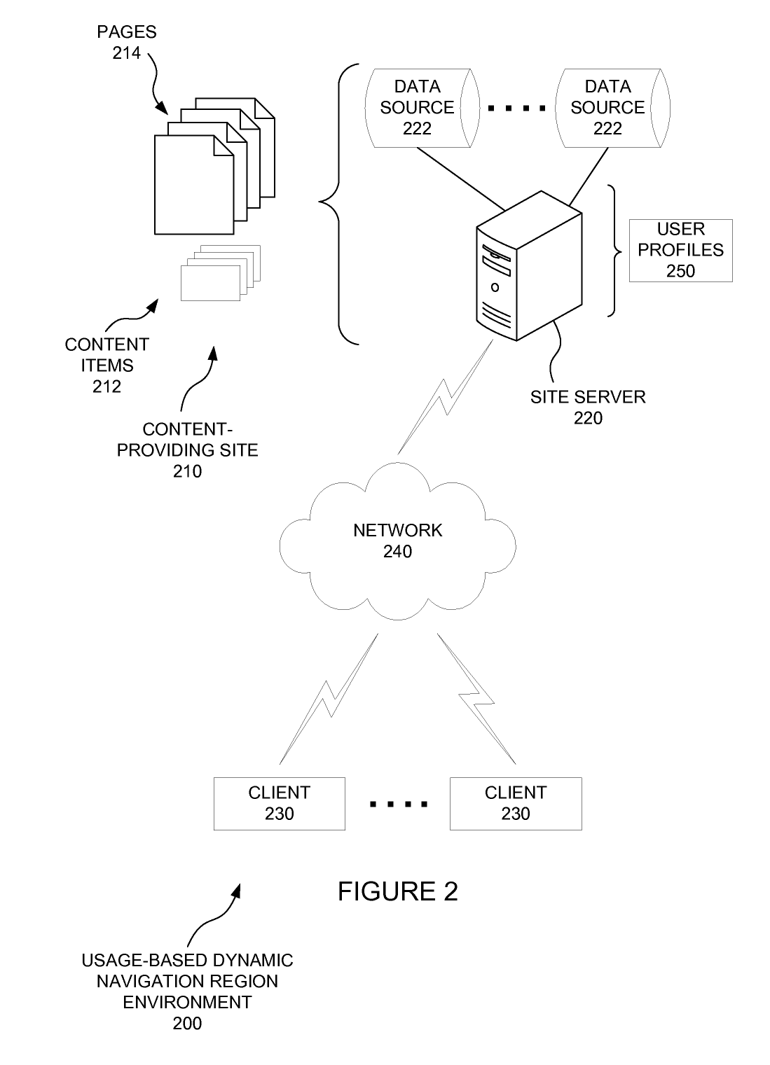

FIG. 2 is a schematic diagram of a site usage-based dynamic navigation region environment (200) in conjunction with which one or more of the described embodiments may be implemented. The environment (200) can include a site (210), which can include content items (212). The content items (212) can include pages (214) and other content items (212) (e.g., libraries, lists, apps, etc.). The site (210) can be hosted on a site server (220). The site server (220) can communicate with data sources (222), which can store underlying information regarding the content items (212) in the site (210).

The site server (220) can communicate with clients (230) to receive requests for content items (212) from the site (210), and to return the content items (212) to the clients (230). For example, the site server (220) and the clients (230) may communicate with each other over a network (240), which may include one or more sub-networks such as a global computer network, one or more local area networks, one or more wide area networks, etc. The site server (220) may maintain user profiles (250) that access the content-providing site (210). Alternatively, the site server (220) may not maintain such profiles, and the profiles may be maintained by the clients (230) or by some other computing environment(s). The profiles (250) may include any of various different types of identifying information, such as addresses of the clients (230) (e.g., internet protocol addresses), usernames, etc.

One possible implementation of a site usage-based dynamic navigation region environment (200) is described below.

A. Regions

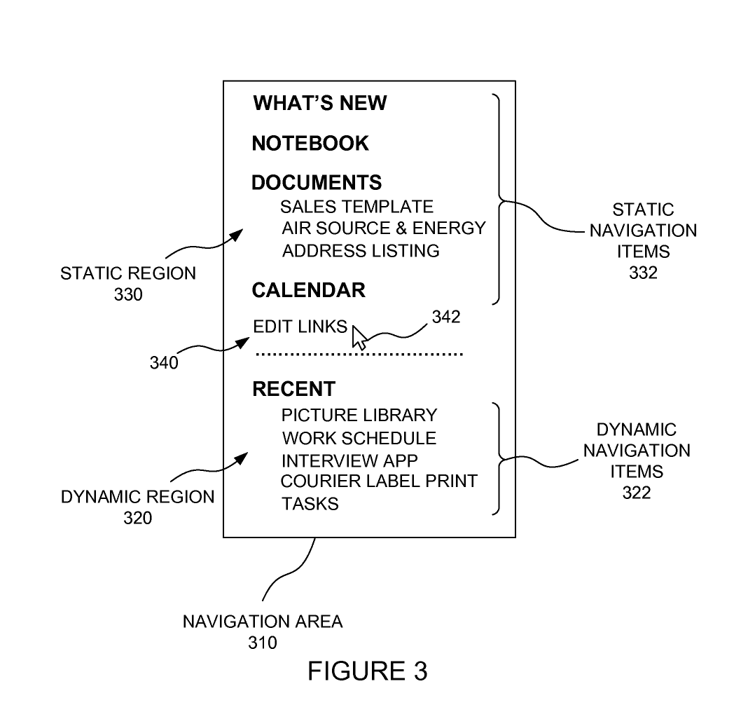

FIG. 3 illustrates an example of a navigation area (310) of a page, such as the pages (214) discussed above. The navigation area (310) can include a dynamic region (320) that can include dynamic navigation items (322). The navigation area (310) can also include a static region (330) that can include static navigation items (332). The dynamic navigation items (322) and the static navigation items (332) can be the same types of navigation items, but can be located in the different respective regions of the navigation area (310). There may be more than one dynamic navigation region and/or more than one static navigation region on a page. For example, each page on a site may have a local static region with navigation items for content within the current site and a global static navigation region with navigation items for navigating to other sites or content items in other sites. Similarly, each page on a site may have a local dynamic region with navigation items for content within the current site, and a global dynamic navigation region with navigation items for content items outside the current site.

B. Storage

The dynamic navigation items (322) can be stored in the same way as the static navigation items (332). For example, the navigation items (322 and 332) can be stored as navigation node objects in a content database, which can be one of the data sources (222) discussed above. Specifically, the content database can include a navigation table, and each navigation item (322 and 332) can be an entry in the table. One or more columns of the table may indicate whether the navigation item (322 or 332) is in the static region (330) or the dynamic region (320). During rendering, only a set number of dynamic navigation items (322) (such as five items) may be displayed in the dynamic region (320). However, more than that set number may be stored to allow de-duplication and pinning of items from the dynamic region (320) to the static region (330). Pinning and de-duplication will be discussed more below. In one implementation, the number of items in the static region (330) plus fifteen more items can be stored. For example, if the static region (330) has seven static navigation items (332) in it currently, the data store for the navigation area (310) can store twenty-two navigation items (322 and 332).

C. Refreshing Data

Updating of the dynamic region (320) can be triggered according to one or more of various different techniques. For example, the updating may be triggered to run automatically according to a set periodic schedule, when a page in the site is requested, or according to some other technique. In one implementation, updating is triggered when a page in the site is requested, if the dynamic region (320) has not been updated in the past twenty-four hours. Accordingly, in this implementation the dynamic region (320) is updated no more than once per day. Specifically, during updating, a property can be stored noting the current date and time. Then, on future accesses of the page that hosts the dynamic region (320), if the date/time is more than one day prior to the value stored in that property, the region can be automatically updated.

Updating may be done according to various techniques to choose the dynamic navigation items (322) that are currently to be included in the dynamic region (320), according to usage of the current site. This usage may be usage that is not profile-specific or user-specific, so that the usage may be usage by any user profile that is able to use the site. The updating may consider one or more of various usage factors, such as creation dates, recency of usage, frequency of usage, etc. For example, queries may be done for one or more of various different types of usage criteria or factors, such as items created most recently, most relevant items in a specified time period such as the past week, items with the most views, recommendations from the site based upon what the current user has changed, etc. Many of these criteria or other criteria could be implemented using search indexes. In one technique, the updating can include the following queries to different data sources:
1. Recently created lists. This query can query a content database of the data sources (222) for the current site (210) for lists created within a period of time, such as lists created in the last fourteen days. More recently created lists can be given higher priority for inclusion of corresponding navigation items in the dynamic region (320).
2. Recently installed “apps”. This query can query a package database of the data sources (222) for the current site (210) for a list of “apps” installed within a period of time, such as within the last fourteen days. More recently installed apps can be given higher priority for inclusion of corresponding navigation items in the dynamic region (320).
3. Recently viewed lists. This query can query a search index for recently viewed list items such as documents within this site. Additionally, sites may be hierarchical in nature, with a site having one or more sub-sites and those sub-sites may have their own sub-sites, etc. In some implementations this query (and possibly the other queries for content items) may also search for items within related sites such as all of the current site's sub-sites. For each result from that query, the system can determine the list that hosts the item and can increment the read count of the hosting list in an array. Then, the array can be sorted by read count. Accordingly, this can result in records of all lists having items that have been viewed in a period of time (e.g., the past fourteen days), sorted according to how many view counts were attributed to each list. Accordingly, lists that have had more view counts can be given higher priority for inclusion of the corresponding navigation items in the dynamic navigation region (320). De-duplication, which is described below, can be run against the results from the query for recently created lists.
4. Recently used “apps”. This query can query a package database for the current site for all “apps” installed on the site. Then, an analytics database can be queried for usage counts of those installed instances of the apps. As with lists, the apps can be sorted according to the number of times the apps have been used in a period of time such as the past fourteen days. The navigation items corresponding to the apps can be prioritized for inclusion in the dynamic region (320) according to those counts. De-duplication, which is described below, can be run against the results of the query for recently created apps.

In one implementation, these queries can be run in order and can stop when they reach a set maximum number of items (e.g., the number of items in the static region plus 15). Alternatively, some other technique could be used for ordering of queries. For example, at least the first two queries could be run, so that at least some lists and at least some apps may be represented if they were created within the set time period. Alternatively, other usage-based criteria could be used. Also, other types of content items besides lists and apps could be analyzed for possible inclusion of corresponding navigation items in the dynamic region (320).

D. De-Duplication

De-duplication is the process of ensuring that no link appears across the navigation regions more than once. De-duplication can run during the refresh process, for example, to ensure that the dynamic region (320) does not include duplicate items. De-duplication may also run during rendering, for example, to ensure that the dynamic region (320) does not show any items that are also in the static region (330) of the navigation area (310). In this implementation, items duplicated between the dynamic and static regions (320 and 330) can be left in the static region (330) and not shown in the dynamic region (320). However, the underlying dynamic region records can be retained for those items that are not shown. This can allow items that have just been unpinned from the static region (330) to appear in the dynamic region (320) if appropriate. For example, a navigation item corresponding to a newly-created “Calendar” content item may have been pinned to the static region (330). If user input is provided instructing that the item be unpinned, then that “Calendar” navigation item can still appear in the dynamic region (320) because the corresponding content item is newly-created.

E. “Pinning” Navigation Items

The dynamic region (320) can suggest to users what navigation items may be useful. Pinning can allow such useful navigation items to be pinned from the dynamic region (320) to the static region (330) so that they can be retained even after they would have been dropped from the dynamic region (320). Pinning a navigation item can remove the navigation item from the dynamic region (320) and add the navigation item to the static region (330). Due to de-duplication, the item will only appear in the static region (330) after this action, until the item is unpinned.

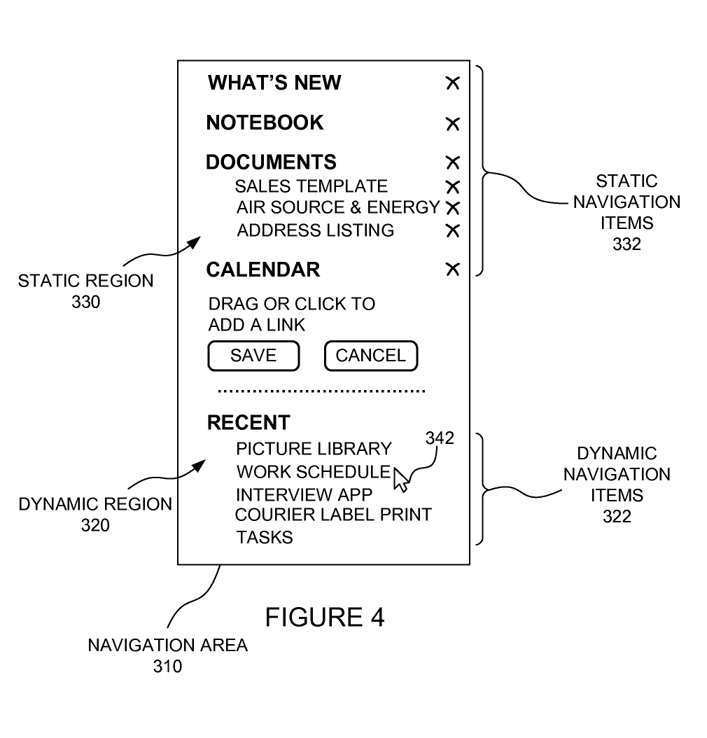

Referring to FIGS. 3-7, an example of user interface features for pinning an item to the static region (330) will be discussed. As illustrated in FIG. 3, a user can select an “edit links” navigation item (340), such as by directing a pointer (342) to the displayed navigation item (340) and making the selection, or in some other manner. This selection can result in the navigation area (310) being revised, as illustrated in FIG. 4, to allow for pinning of navigation items from the dynamic region (320) to the static region (330), and to allow for unpinning of navigation items from the static region (330).

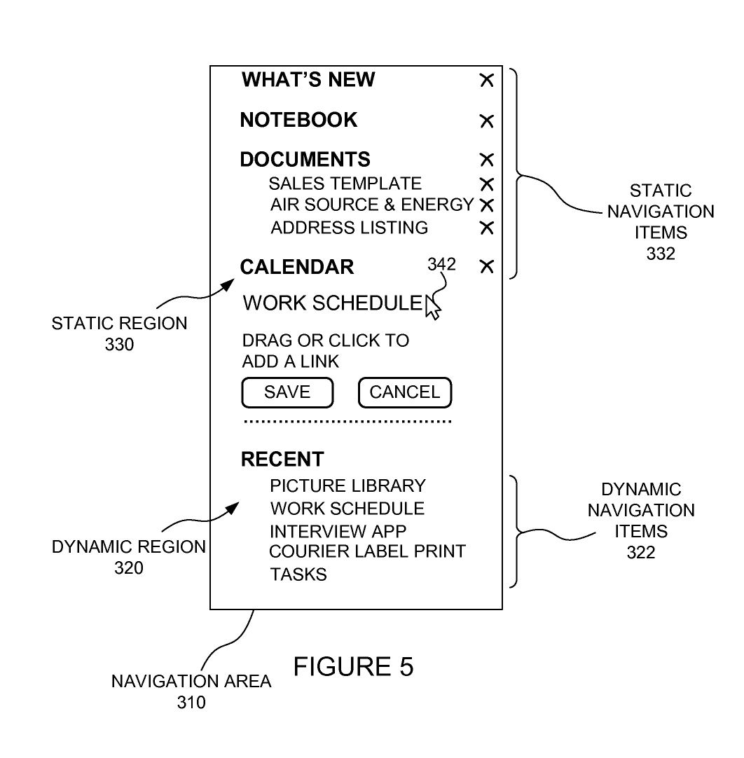

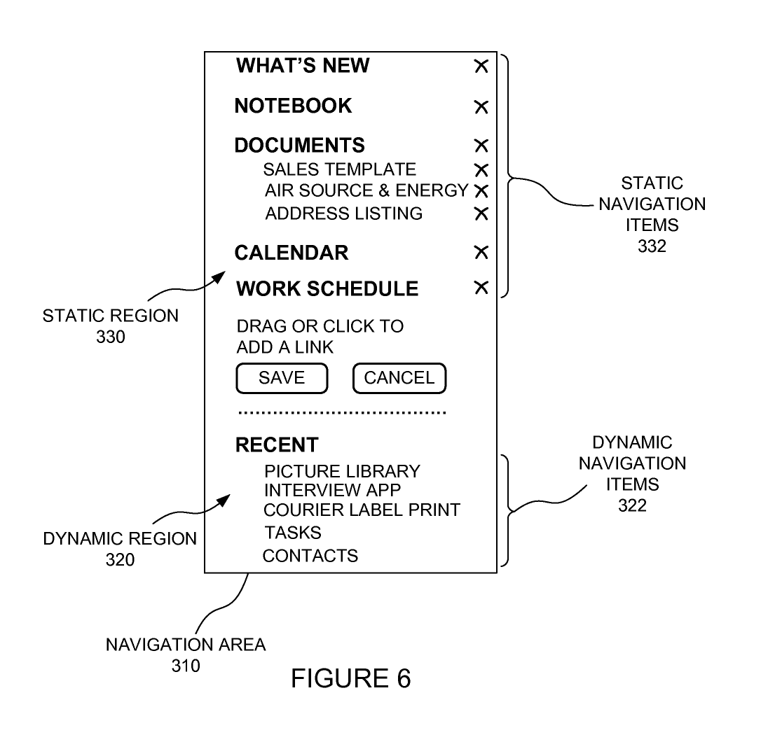

Referring to FIG. 4, a dynamic navigation item (322) (the “WORK SCHEDULE” navigation item) can be selected, such as by using a pointer (342), and the dynamic navigation item (322) can be dragged from the dynamic region (320) to the static region (330), as shown in FIG. 5. As is illustrated in FIG. 6, when the newly-pinned navigation item is added to the static region (330), that newly-pinned item can be removed from the dynamic region (320). Additionally, another navigation item (“CONTACTS” in FIG. 6) can be added to the dynamic region (320) to replace the item that was removed from the dynamic region (320).

Items can also be unpinned from the static region (330). For example, in the illustrated navigation area (310) of FIGS. 4-6, the X-shaped icons to the right of the static navigation items (332) can be selected to unpin the corresponding static navigation item (332) from the static region (330). When an item is unpinned in this manner, it is removed from the static region (330). However, the item may be added to the dynamic region (320) if the item currently meets the criteria for adding items to the dynamic region (320) (e.g., if the item was recently created, etc.).

### III. Site Usage-Based Dynamic Navigation Region Techniques

Several site usage-based dynamic navigation techniques will now be discussed. Each of these techniques can be performed in a computing environment. For example, each technique may be performed in a computer system that includes at least one processor and memory including instructions stored thereon that when executed by at least one processor cause at least one processor to perform the technique (memory stores instructions (e.g., object code), and when processor(s) execute(s) those instructions, processor(s) perform(s) the technique). Similarly, one or more computer-readable storage media may have computer-executable instructions embodied thereon that, when executed by at least one processor, cause at least one processor to perform the technique.

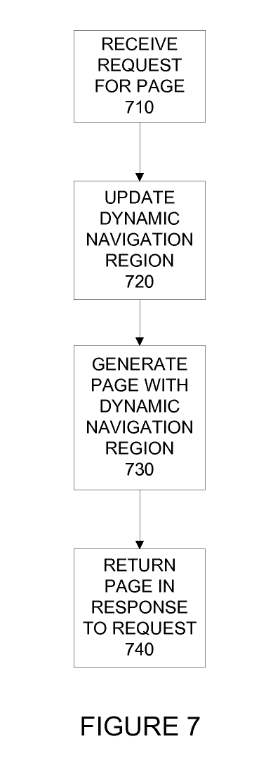

Referring to FIG. 7, a site usage-based dynamic navigation technique will be discussed. The technique can include receiving (710) a request for a page in a site. The page can include a dynamic navigation region. The dynamic region can be automatically updated (720) based on usage of the site by a plurality of user profiles. The updating (720) can include querying multiple sources of navigation item data and compiling a record of dynamic navigation items to be displayed in the dynamic navigation region. Querying navigation item data can include querying at least one search index. The page can be generated (730) with the dynamic navigation region, and the page can be returned (740) in response to the request for the page. The technique may further include de-duplicating navigation items identified by the multiple sources of navigation data, such as by filtering out duplicate navigation items prior to storage and/or prior to rendering or generation of the page.

In addition to the dynamic navigation region, the page may also include a static navigation region that includes one or more static navigation items. The technique may be such that the static navigation items are not automatically updated. The technique can include updating the static navigation region as directed by user input. For example, this updating may include receiving a request to pin a navigation item from the dynamic navigation region to the static navigation region. In response to this request to pin, the page can be updated by adding the pinned navigation item to the static navigation region. The updated page can be returned with the pinned navigation item added to the static navigation region. Updating the page may also include removing the pinned navigation item from the dynamic navigation region.

The request for a page may be a first request from a first user profile. The method may further include receiving a second request for the page from a second user profile, and returning the page in response to the second request for the page. In some situations (e.g., if the dynamic navigation region has not been updated between page requests), the dynamic region may remain the same when the page is returned in response to the first request and when the page is returned in response to the second request. Also, the page may be a first page, and the technique may further include receiving a request for a second page in the site, and returning the second page in the site in response to that request, with the second page including the dynamic navigation region. The dynamic navigation region may be the same in the first page and the second page, although the region may be different if the region has been updated between returning the first page and returning the second page. The first and second pages may also include the same static navigation region (although the static region may also have been updated between requests). Indeed, in some cases, the dynamic and static regions may be the same across all pages in the site that include navigation regions.

Automatically updating (720) the dynamic navigation region may include evaluating candidate navigation items based on one or more factors to determine which navigation items to include in the dynamic navigation region. The factor(s) may include frequency of use of content items corresponding to the candidate navigation items, how recently content items corresponding to the candidate navigation items have been used, and/or how recently content items corresponding to the candidate navigation items were created.

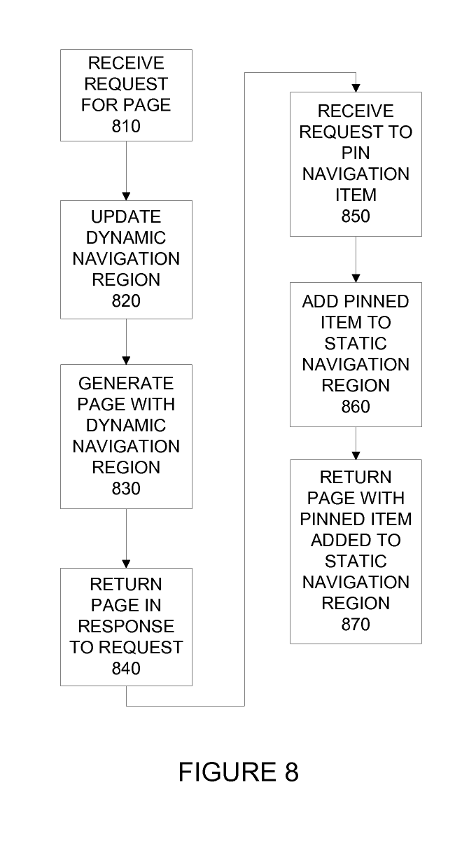

Referring now to FIG. 8, another site usage-based dynamic navigation technique will be discussed. The technique can include receiving (810) a request for a page in a site. The page can include a dynamic navigation region and a static navigation region. The dynamic navigation region can be automatically updated (820) based on usage of the site by multiple user profiles. The page can be generated (830) with the dynamic navigation region, and the page can be returned (840) in response to the request for the page. A request to pin a navigation item from the dynamic navigation region to the static navigation region can be received (850). In response to the request to pin, the pinned navigation item can be added (860) to the static navigation region. The page can be returned (870) with the pinned navigation item added to the static navigation region. The technique may further include, in response to the request to pin, removing the pinned navigation item from the dynamic navigation region.

The technique of FIG. 8 may further include receiving a request to unpin a navigation item from the static navigation region. In response to the request to unpin, the page may be updated by removing the unpinned navigation item from the static navigation region and returning the page with the unpinned navigation item removed from the static navigation region.

The technique may further include, in response to the request to unpin, determining whether the unpinned navigation item meets criteria for being included in the dynamic navigation region. If the unpinned item meets criteria for being included in the dynamic navigation region, then the unpinned item may be added to the dynamic navigation region. For example, as discussed above, the record for the navigation item in the dynamic region may be retained while the navigation item is pinned to the static region, even though the navigation item is not shown in the dynamic region during that time. When the item is unpinned, that record can be evaluated to determine if the navigation item meets the criteria for inclusion in the dynamic region, such as according to the usage factors discussed above.

The technique may further include de-duplication of navigation items while selecting navigation items for inclusion in the dynamic navigation region. For example, this may include the de-duplication at refresh time discussed above and/or the de-duplication at rendering time, also discussed above.

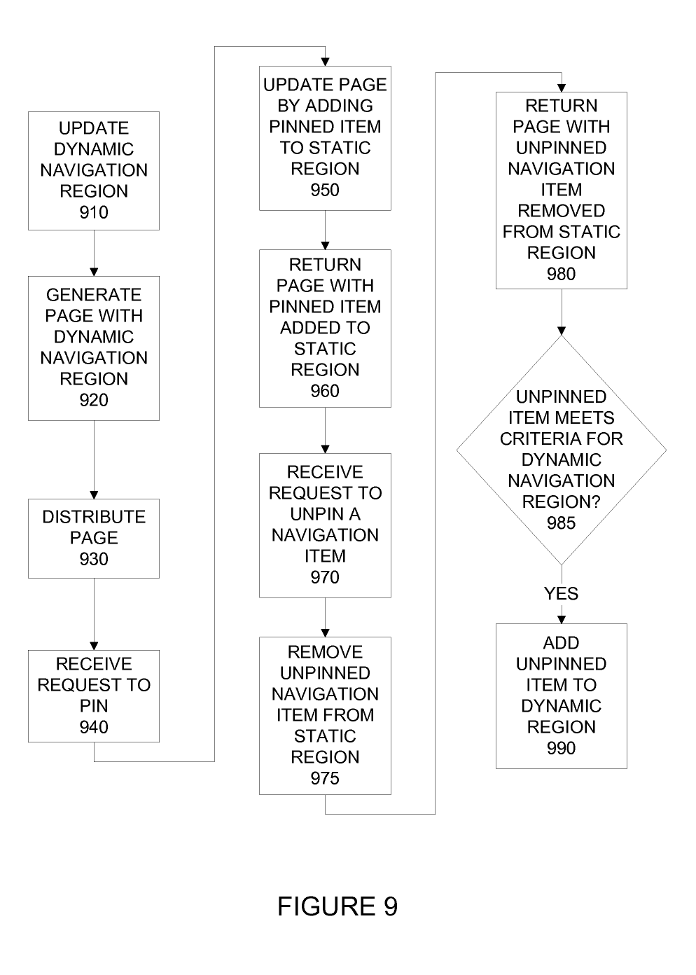

Referring now to FIG. 9, yet another site usage-based dynamic navigation technique will be discussed. The technique can include automatically updating (910) a dynamic navigation region of a page in a site based on usage of the site by multiple user profiles. The updating (910) can include querying multiple sources of navigation item data, compiling a record of dynamic navigation items to be displayed in the dynamic navigation region, and evaluating the records. Querying multiple sources of navigation item data can include querying at least one search index. The page can be generated (920) with the dynamic navigation region. The page can be distributed (930) in response to requests for the page from a plurality of user profiles. The dynamic navigation region may or may not be updated between such requests for the page.

A request to pin a navigation item from the dynamic navigation region to a static navigation region on the page can be received (940). In response to the request to pin, the page can be updated (950) by adding the pinned navigation item to the static navigation region, and returning (960) the page, with the pinned navigation item added to the static navigation region and with the pinned navigation item removed from the dynamic navigation region. A request to unpin a navigation item (which may or may not be the same as the pinned navigation item discussed above) from the static navigation region can be received (970). In response to the request to unpin, the following can be performed: the unpinned navigation item can be removed (975) from the static navigation region; the page can be returned (980) with the unpinned navigation item removed from the static navigation region; it can be determined (985) whether the unpinned navigation item meets criteria for being included in the dynamic navigation region; and if the unpinned navigation item meets the criteria for being included in the dynamic region, then the unpinned item can be added (990) to the dynamic navigation region.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/we claim:

1. A computer-implemented method, comprising:
receiving a request for a page in a site, the page comprising a dynamic navigation region;
automatically updating the dynamic navigation region based on usage of the site by a plurality of user profiles, the updating comprising querying multiple sources of navigation item data and compiling a record of dynamic navigation items to be displayed in the dynamic navigation region;
generating the page with the dynamic navigation region; and
returning the page in response to the request for the page.

2. The method of claim 1, wherein querying multiple sources of navigation item data comprises querying at least one search index.

3. The method of claim 1, wherein the page further comprises a static navigation region comprising one or more static navigation items and wherein the method further comprises updating the static navigation region as directed by user input.

4. The method of claim 3, wherein updating the static navigation region as directed by user input comprises:
receiving a request to pin a navigation item from the dynamic navigation region to the static navigation region; and
in response to the request to pin:
updating the page by adding the pinned navigation item to the static navigation region; and
returning the updated page with the pinned navigation item added to the static navigation region.

5. The method of claim 4, wherein updating the page in response to the request to pin further comprises removing the pinned navigation item from the dynamic navigation region.

6. The method of claim 3, wherein the static navigation items are not automatically updated.

7. The method of claim 1, further comprising de-duplicating navigation items identified by the multiple sources of navigation data.

8. The method of claim 1, wherein the request for the page is a first request from a first user profile, and wherein the method further comprises:
receiving a second request for the page from a second user profile; and
returning the page in response to the second request for the page.

9. The method of claim 8, wherein the dynamic navigation region remains the same when the page is returned in response to the first request and when the page is returned in response to the second request.

10. The method of claim 1, wherein the page is a first page and wherein the method further comprises:
receiving a request for a second page in the site; and
returning the second page in the site in response to the request for the second page, with the second page in the site including the dynamic navigation region.

11. The method of claim 1, wherein automatically updating the dynamic navigation region comprises evaluating candidate navigation items based multiple factors to determine which navigation items to include in the dynamic navigation region.

12. The method of claim 1, wherein automatically updating the dynamic navigation region comprises evaluating candidate navigation items based on one or more factors to determine which navigation items to include in the dynamic navigation region, the one or more factors comprising frequency of use of content items corresponding to the candidate navigation items.

13. The method of claim 1, wherein automatically updating the dynamic navigation region comprises evaluating candidate navigation items based on one or more factors to determine which navigation items to include in the dynamic navigation region, the one or more factors comprising how recently content items corresponding to the candidate navigation items have been used.

14. The method of claim 1, wherein automatically updating the dynamic navigation region comprises evaluating candidate navigation items based on one or more factors to determine which navigation items to include in the dynamic navigation region, the one or more factors comprising how recently content items corresponding to the candidate navigation items were created.

15. A computer system comprising:
at least one processor; and
memory comprising instructions stored thereon that when executed by at least one processor cause at least one processor to perform acts comprising:
receiving a request for a page in a site, the page comprising a dynamic navigation region and a static navigation region;
automatically updating the dynamic navigation region based on usage of the site by a plurality of user profiles;
generating the page with the dynamic navigation region;
returning the page in response to the request for the page;
receiving a request to pin a navigation item from the dynamic navigation region to the static navigation region; and
in response to the request to pin, performing the following acts:
adding the pinned navigation item to the static navigation region; and
returning the page with the pinned navigation item added to the static navigation region.

16. The computer system of claim 15, wherein the acts further comprise, in response to the request to pin, removing the pinned navigation item from the dynamic navigation region.

17. The computer system of claim 16, wherein the acts further comprise:
receiving a request to unpin a navigation item from the static navigation region; and
in response to the request to unpin:
updating the page by removing the unpinned navigation item from the static navigation region; and
returning the page with the unpinned navigation item removed from the static navigation region.

18. The computer system of claim 17, wherein the acts further comprise, in response to the request to unpin:
determining whether the unpinned navigation item meets criteria for being included in the dynamic navigation region; and
if the unpinned item meets criteria for being included in the dynamic navigation region, then adding the unpinned item to the dynamic navigation region.

19. The computer system of claim 15, wherein the acts further comprise de-duplicating navigation items while selecting navigation items for inclusion in the dynamic navigation region.

20. One or more computer-readable storage media having computer-executable instructions embodied thereon that, when executed by at least one processor, cause at least one processor to perform acts comprising:
automatically updating a dynamic navigation region of a page in a site based on usage of the site by a plurality of user profiles, the updating comprising querying multiple sources of navigation item data, compiling records of dynamic navigation items to be displayed in the dynamic navigation region, and evaluating the records, querying multiple sources of navigation item data comprising querying at least one search index;
generating the page with the dynamic navigation region;
distributing the page in response to requests for the page from a plurality of user profiles;
receiving a request to pin a navigation item from the dynamic navigation region to a static navigation region on the page; and
in response to the request to pin:
updating the page by adding the pinned navigation item to the static navigation region;
returning the page with the pinned navigation item added to the static navigation region and with the pinned navigation item removed from the dynamic navigation region;
receiving a request to unpin a navigation item from the static navigation region; and
in response to the request to unpin:
removing the unpinned navigation item from the static navigation region;
returning the page with the unpinned navigation item removed from the static navigation region;
determining whether the unpinned navigation item meets criteria for being included in the dynamic navigation region; and
if the unpinned navigation item meets the criteria for being included in the dynamic navigation region, then adding the unpinned item to the dynamic navigation region.
